(19) United States
(12) Patent Application Publication
(10) Pub. No.: US 2020/0134540 A1
(43) Pub. Date: Apr. 30, 2020

(54) Organizational Network Analysis System For Mergers, Acquisitions and Reorganizations

(71) Applicant: Cognitive Talent Solutions, Inc., Dover, DE (US)

(72) Inventors: Francisco MARIN RUZ, Córdoba (ES); Viktor HRTANEK, Slovakia (SK)

(21) Appl. No.: 16/168,970

(22) Filed: Oct. 24, 2018

(51) Int. Cl. G06Q 10/06; G06F 17/30

(52) U.S. Cl. CPC G06Q 10/063118; G06F 17/30339; G06F 17/30498; G06Q 10/063112

(57) ABSTRACT

The invention performs a simulation of a new organization, created as a result of merger, acquisition or reorganization, including the steps of receiving information about teams in the new organization, information about open positions, at least one employee table that provides records for a plurality of employees, where at least one of the employees is to be assigned to a team in the new organization; matching constraints that are used to match employees with teams, and balancing constraints that are used to balance teams, for at least one employee to be assigned to a team, determining that the employee matches an open position on a team based on the matching constraints, assigning the employee to the open position on the team; and for at least one team, reassigning an employee to a different team based on the balancing constraints.

### FIELD OF THE INVENTION

The present invention relates to the ability to simulate or forecast organization changes may result from mergers, acquisitions and reorganizations.

### BACKGROUND OF THE INVENTION

Large organizations frequently acquire companies, merge with companies and reorganize. In many cases, mergers and acquisitions fail to create shareholder value due issues that arise during post-merger or post-acquisition integration.

One important aspect of post-merger or post-acquisition integration is the integration of the employees of the two organizations being combined. This aspect is especially important in cases where the combined organization is very large, e.g. numbering tens of thousands of employees.

An emerging area, referred to as organizational network analysis (ONA), provides techniques for studying and modeling people, tasks, groups, knowledge and resources of organizational systems. ONA tools have emerged that provide statistical and graphical tools for analyzing the human side of organizations.

Thus, it would be helpful to provide a tool to business managers that simulates organizational restructuring scenarios that may result from acquisitions, mergers and reorganizations.

### SUMMARY OF THE DESCRIPTION

The present invention concerns methods, devices and systems for simulating a new organization that may result from an acquisition, merger or reorganization.

The invention performs a simulation of a new organization, created as a result of merger, acquisition or reorganization, including the steps of receiving information about teams in the new organization, information about open positions, at least one employee table that provides records for a plurality of employees, where at least one of the employees is to be assigned to a team in the new organization, matching constraints that are used to match employees with teams, and balancing constraints that are used to balance teams, for at least one employee to be assigned to a team, determining that the employee matches an open position on a team based on the matching constraints, assigning the employee to the open position on the team; and for at least one team, reassigning an employee to a different team based on the balancing constraints.

The invention defines teams of non-managerial employees, each of which reports to a first line manager and attempts to fill open positions, defined by matching variables. After non-managerial employees have been assigned to teams based on the matching variables a process is performed to balance the teams. Each team is sequentially processed to determine if there is another team that has a complementary imbalance. If a complementary imbalance is detected, than at least one non-managerial employee is swapped to reduce the imbalance.

### BRIEF DESCRIPTION OF THE DRAWINGS

The subject invention will be more fully understood and appreciated from the following detailed description, taken in conjunction with the drawings in which:

FIG. 1 is a simplified block diagram of an organizational network analysis (ONA) system that simulates organizational changes due to mergers, acquisitions and reorganizations.

FIG. 2 is an example of a human resource data set provided to an ONA server for analysis.

FIG. 3 is an exemplary graphical result of a simulation performed by the ONA system.

FIG. 4 illustrates an exemplary embodiment of a general method for simulating post-acquisition integration, post-merger integration and internal reorganization.

FIG. 5 is a simplified flowchart of one exemplary method 500 for matching non-managerial employees to target teams.

FIG. 6 provides a visual illustration of the method of FIG. 5.

FIG. 7 is a flowchart that illustrates one exemplary method for balancing a group of teams.

FIG. 8 is a system diagram that shows components of one exemplary operating environment in which the invention may be practiced.

FIG. 9 is a block diagram that depicts the software modules of an ONA server.

The figures depict embodiments of the present invention for purposes of illustration only. One skilled in the art will readily recognize from the following discussion that alternative embodiments of the structures and methods illustrated herein, as well as combinations of embodiments, may be employed without departing from the principles of the invention described herein.

### DETAILED DESCRIPTION

The invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be embodied as methods, processes, systems, business methods or devices. Accordingly, the present invention may take the form of an entirely hardware embodiment, an entirely software embodiment or an embodiment combining software and hardware aspects. The following detailed description is, therefore, not to be taken in a limiting sense.

As used herein the following terms have the meanings given below:

User—means an individual that uses a mobile device, PC or other client device to access services provided by the present invention across a network. In certain embodiments, the invention may be provided on a single computer, such as a personal computer.

Human resources (HR) staff—means an individual or entity that provides inputs to the invention about the staff. HR staff may also set goals such as percentages that are used by the invention.

First line manager—means a manager to whom a group of non-managerial employees or staff report. First line managers report to second line managers and so forth.

Factor variables—means variables whose values fall into categories. In some cases, these are qualitative variables such as the degree of engagement that an employee exhibits, or an employee's current risk of burnout. In other cases, the values may be numerical, such as age, which can also be categorized, such as into age groups.

Numerical variables—mean variables that have numerical values, such as age or income. In most cases, factor variables can be converted to numerical variables for mathematical processing.

Team—refers to an organizational unit that includes non-managerial staff and a first line manager.

### Generalized Operation

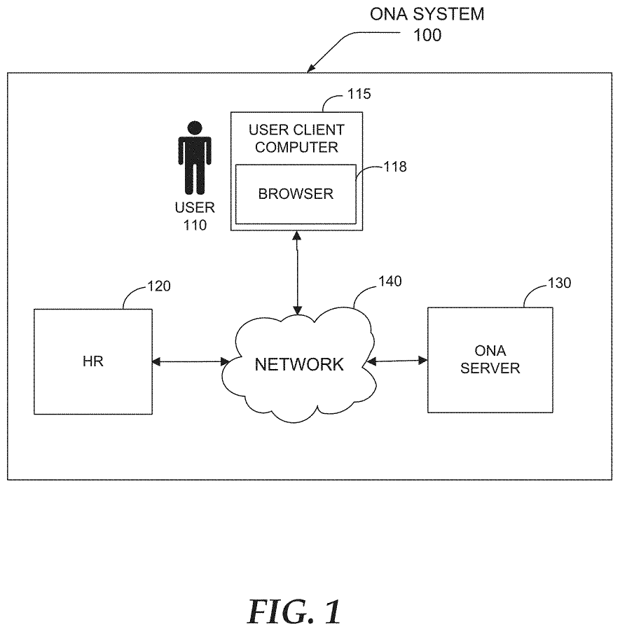

The operation of certain aspects of the invention is described below with respect to FIGS. 1-6.

FIG. 1 is a simplified block diagram of an organizational network analysis (ONA) system 100 that simulates organizational changes due to mergers and acquisitions. A user 110 uses a web browser or other client application, referred to simply as browser 118, such as MICROSOFT INTERNET EXPLORER or MOZILLA FIREFOX, to visit a website that enables him/her to perform functions provided by an ONA server 130. Browser 118 transmits requests for information and services to ONA server 130, which in turns performs requested analysis or other services and returns results.

Although ONA system 100, is illustrated in FIG. 1 as a client-server architecture, other architectures may be employed. For example, ONA system 100 may operate entirely on a personal computer or other computing device. As another example, ONA server 130 functions may be performed by a cloud service.

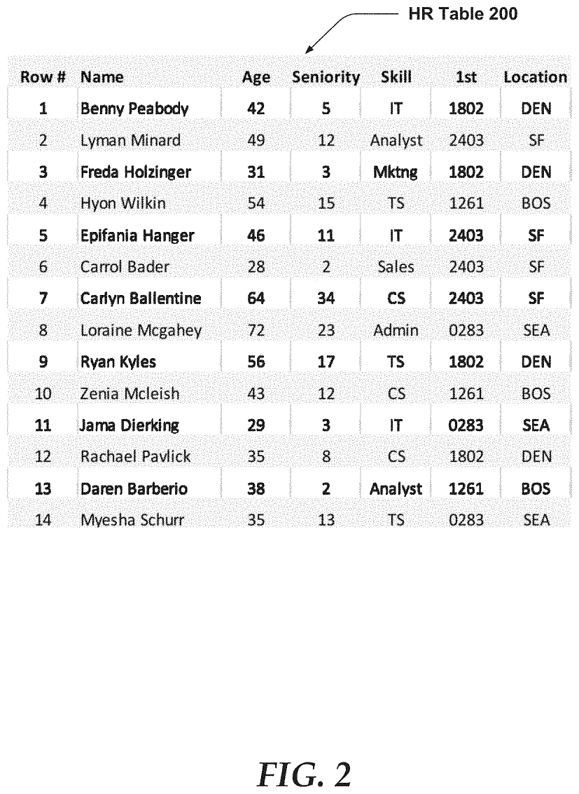

Data inputs, typically in the form of human resources data sets, or tables, are typically provided by a human resources department, referred to as HR 120 for processing by ONA server 130. An example, of a human resource data set is provided in FIG. 2. In addition, HR 120 specifies open positions, in the form of matching constraints and team objectives in the form of balancing constraints.

ONA server 130 takes as input one or more HR tables. Each HR table provides information about the employees in an organization. ONA server 130 evaluates the HR tables and generates or simulates how a new organization might appear given the constraints. Typically, the objective is to provide a view of an organization that might result from a merger, acquisition, or reorganization given objectives such as the maximum span of control for managers, or a target balance of gender, or seniority within a team.

It may be appreciated, that while ONA system 100 is intended to simulate organizational shifts due to mergers, acquisitions, or reorganizations; its use is not so limited, and it may be used for other applications without departing from the scope and spirit of the subject invention.

FIG. 2 is an exemplary human resources (HR) table 200 that is provided as input to ONA server 130. Each row in HR table 200 provides information about a single employee. The columns in each row correspond to characteristics or fields. The columns in HR table 200 provide a row number, employee name, age, seniority in years, skill, employee number of the 1^{st} line manager, and the employee's office location. In certain embodiments, other columns are also included. For example, an employee's gender, employee number, the name of the employee's second and third level manager, type and attained level of education, may also be included.

It may be appreciated that while the term table is herein to refer to refer to data sets that describe characteristics of employees and characteristics such as those provided by HR 120 and which are subsequently processed and created by system 100, any type of data format or data structure may be used including inter alia a database file, a spreadsheet, a word processing file, or a formatted text file. Thus, the term table is used herein to generically refer to a data structure that holds structured data. Similarly, the terms rows and columns are used as a convenient way to refer to data elements but their use does not imply or, require that a specific type of data format be employed.

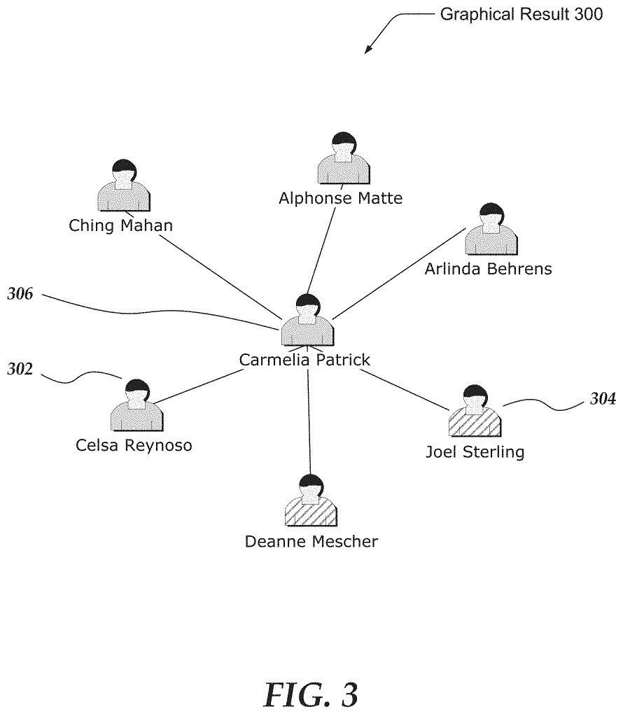

FIG. 3 is an exemplary graphical depiction 300 of one team created by ONA server 130. The team includes four non-managerial employees 302 from an acquiring organization, two non-managerial employees 304, indicated by the striped shirts, from an organization being acquired, and a first line manager 306. Generally, non-managerial employees 302, 304 have links or edges that connect to a first line manager 304. First line managers, in turn each have a link that connects to a second level manager. And second level managers typically have a link that connects to a third level manger. It may be appreciated that the number of levels is arbitrary, and the invention serves equally well for any number of organizational levels.

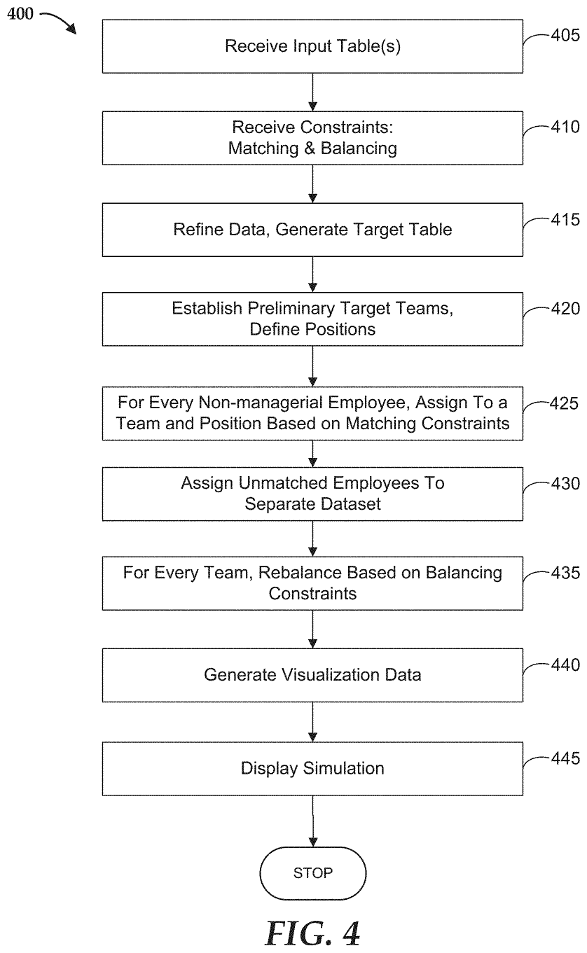

It will be understood that each block of the flowchart or component diagram illustrated in FIGS. 4-7 and 9, and combinations of blocks in the illustrations, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps that implement the actions specified in the flowchart block or blocks to be performed by the processor to produce a computer-implemented process or method. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the illustrations may also be performed concurrently with other blocks or combinations of blocks, or even in a different sequence than illustrated without departing from the scope or spirit of the invention.

Accordingly, blocks of the illustrations support combinations of means for performing the specified actions, combinations of steps for performing the specified actions and program instruction means for performing the specified actions. It will also be understood that each block of the flowchart illustration, and combinations of blocks in the illustrations, can be implemented by special purpose hardware-based systems that perform the specified actions or steps, or combinations of special purpose hardware and computer instructions.

System 100 is well suited to simulate three common types of organizational change: post-acquisition integration, post merger integration and internal reorganization. A post-acquisition integration simulation allocates non-managerial employees from a company being acquired to the acquiring company. Post merger integration simulation allocates non-managerial employees from two companies that are merging to a new organization. Internal reorganization simulation reallocates non-managerial employees in a single organization, respecting various constraints.

While each of the aforementioned applications have certain differences, a general method, can be used to implement all three. FIG. 4 illustrates an exemplary embodiment of a general method for simulating post-acquisition integration, post-merger integration and internal reorganization. Method 400 is performed by ONA server 130. At step 405 the method received input tables, typically from HR 120.

As described in Table 1, below, the input tables and constraints are specific to the application or simulation being performed.

TABLE 1
Input Tables

| Application | Input Tables Required |
|---|---|
| Post-acquisition integration | HR table for acquiring company; |
| | HR table for acquired company |
| Post-merger integration | HR table for acquiring company; |
| | HR table for acquired company |
| Internal reorganization HR | table for company that is |
| | reorganizing |

At step 410 the ONA server 130 receives matching and balancing constraints or criteria. These two types of constraints are applied as threshold values for corresponding matching and balancing variables.

Matching variables are used to match an employee with a position requirement. For example, a team may have a requirement for a senior IT staff or a Ph.D in chemistry for the Denver, Colo. team.

Balancing variables measure the composition of a team. Example balancing constraints that are applied to balancing variables are: at least 20% of team members are female, at least 30% of staff in a team are junior level, or team size should not exceed 10 persons.

Examples of types of matching and balancing variables are given below in Table 2.

TABLE 2
Constraints

| Matching Variables | Balancing Variables |
|---|---|
| Location | Demographics, including age |
| | group, gender, race |
| Skill | Team size/Span of control (for |
| | team manager) |
| Seniority | Seniority |
| Education | Education |
| | Engagement |

As illustrated in Table 2, in some cases a variable can be both a matching and a balancing variable; in other cases, a variable is used as one of a matching or balancing variable but not the other. For example, in some cases seniority may be used to balance teams while in other cases it may be a job requirement, e.g. Senior Mechanical Engineer. A constraint is set by establishing an objective or threshold for a balancing variable, e.g. at least 20% of a team are senior members and at least 25% are junior members. It may be appreciated that method 400 attempts to balance all teams in a new organization by achieving the specified balancing constraints; however, it is not possible to guarantee that all or any of the constraints will be met. So method 400 attempts to get as close as possible, i.e. as close as the data permits, to reaching the balancing constraints. Additionally, matching and balancing variables may each have associated weights that indicate their relative priority or importance, and which are used in method 400.

At step 415 the input data is refined or processed as necessary and a target table is created. Generally, factor variables, i.e. variables that represent categories such as male/female or seniority, which may be categorized as junior, middle, senior are converted to numerical variables for further processing. Processing of numerical variables may include statistical calculations such as mean, standard deviation, and logarithms. Additionally, a target table that is used to format the data that represents a new organization may be prepared at this step. For example, in the case of post-acquisition integration simulation: (1) a new table that includes all the non-managerial employees of the acquiring company and the acquired company may be generated; and (2) reporting information such as first line manager is cleared for all employees of the acquired company. In the case of post-merger integration: (1) a new table that includes all the non-managerial employees of the acquiring organization and the acquired company may be generated; and (2) reporting information such as first line manager is cleared for all employees. In the case of internal reorganization, (1) a new table that corresponds to the input table for the organization being reorganized is created and (2) reporting information in the new table is cleared.

At step 420 preliminary target teams are established. These are the teams that are likely to exist after the reorganization. For example, in a post-acquisition integration, each first line manager of the acquiring company represents a team. In post-merger integration, each first line manager of both of the two organizations being merged represents a team. Additionally, positions to be filled in each team are defined. Generally, a position is defined by specifying one or more matching variables, e.g. location, role, seniority, education as described in Table 2.

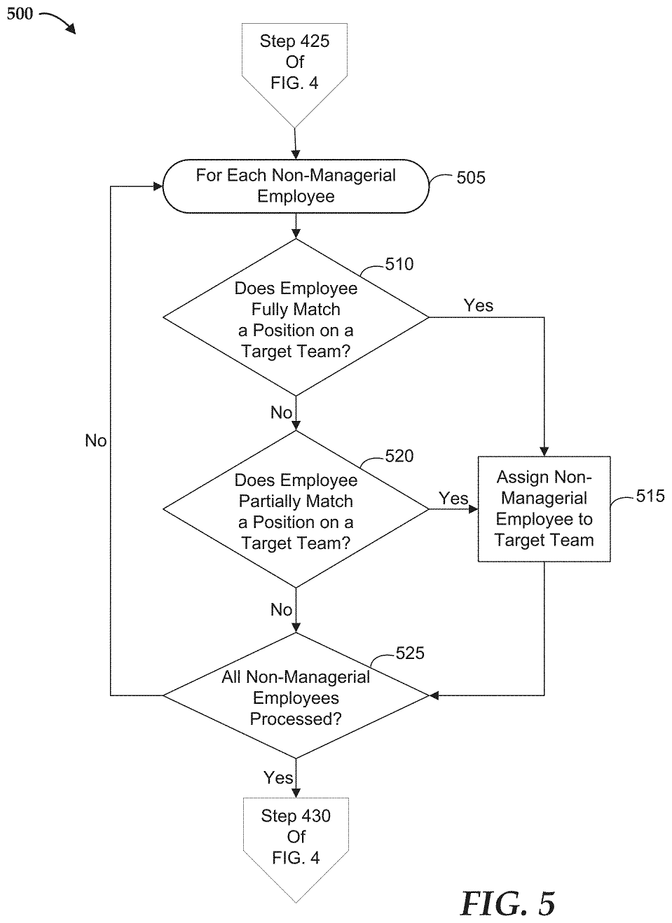

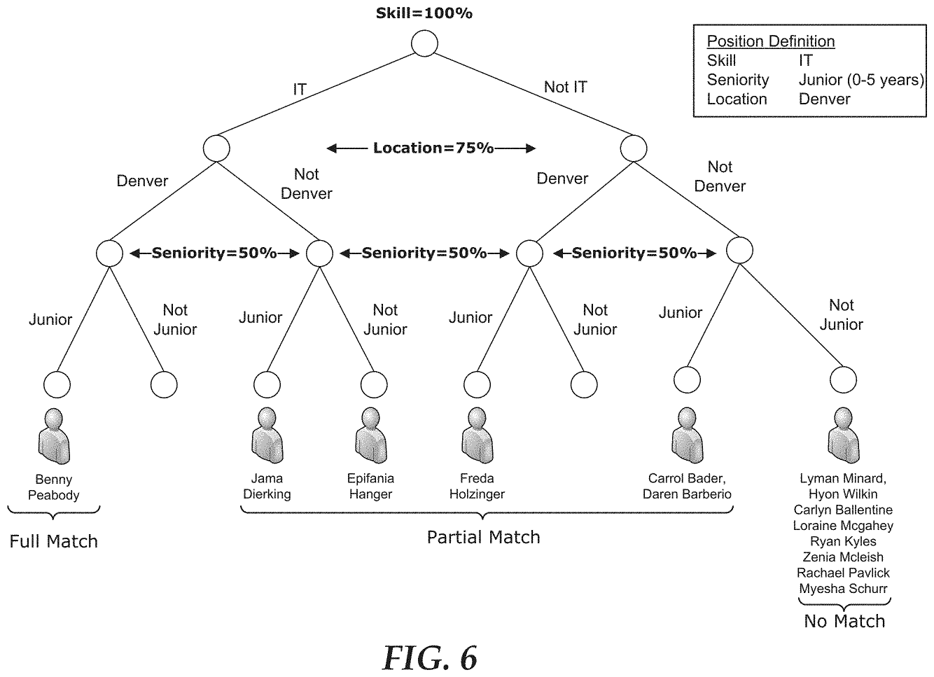

At step 425, each non-managerial employee of the organization being reorganized is sequentially processed to determine if they match an open position on a team based on matching constraints. If a match is determined, then the employee is assigned to the team and position. Matching is performed by comparing the open positions specified at step 420 with the information in the relevant row of an HR table for the employee. In certain embodiments, a partial match may be acceptable. Further, weights may be specified for matching variables. One algorithm that may be used to match positions to employees is specified with reference to FIG. 5. Further, one embodiment of the processing described with reference to FIG. 5 is illustrated in FIG. 6.

At step 430, after each non-managerial employee has been processed to determine if there is a match with a team, any unmatched employees are added to a table or dataset used for that purpose. Essentially, at this step, unmatched employees are taken out of consideration and are not further processed as part of method 400. Unmatched employees are typically evaluated separately by managers.

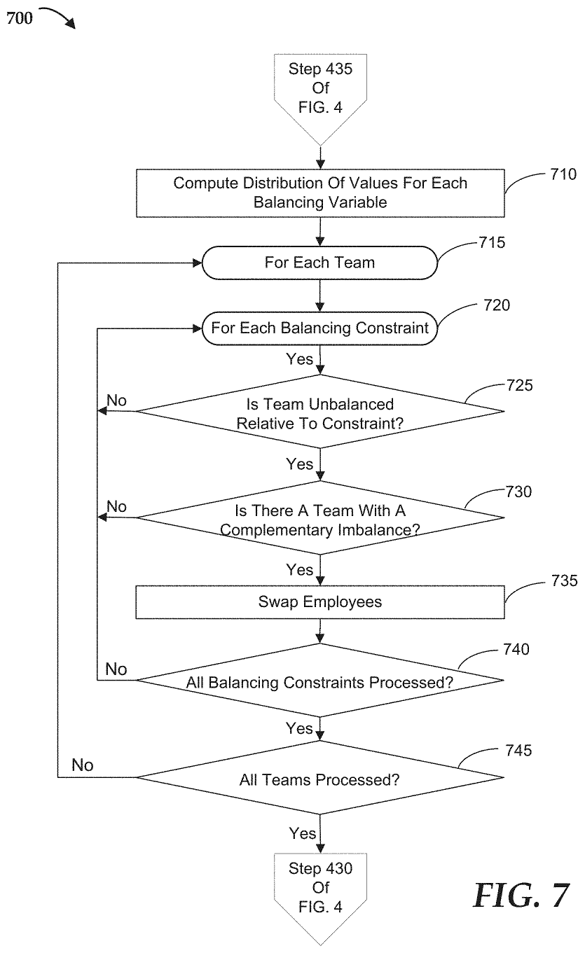

At step 435, each team is rebalanced based on the balancing constraints specified at step 410. One method of rebalancing teams is described with reference to FIG. 7 hereinbelow.

At this point, creation of a new organization is complete. At step 440 data from the results table is used to create the data structures required to visualize the result. Typically, this involves creating labeled nodes and edges that can be displayed by a specialized graphical software package that displays a tree structure.

At step 445 the resulting organization, as generated by the simulation is displayed.

Note that in certain embodiments, steps 440 and 445 may not be performed. For example, in a very large organization it may be unwieldy to graphically display the simulation results. In such cases method 400 may terminate after step 435.

FIG. 5 is a simplified flowchart of one exemplary method 500 for matching non-managerial employees to target teams. Method 500 is one method for performing step 425 of method 400. Step 505 shows that method 500 is a loop that sequentially processes non-managerial employees that are being assigned from one organization to new, reorganized or merged organization. In the case of post-acquisition merger simulation the employees being assigned belong to the acquired organization; in the case of post-merger simulation employees from two or more organizations being merged are assigned to a new organization; while, in the case of an internal reorganization the employees being assigned belong to the organization or parts of an organization that are being reorganized.

As described with reference to method 400, prior to execution of method 500 target teams have been created and open positions have been defined based on matching variables. At step 510 a determination is made for the employee being processes as to whether he/she fully matches a position on a target team. For example, if a position is defined as Location=Denver, Seniority=Senior, Skill=IT the row in an HR table that corresponds to the employee being processed would have to match exactly on all three matching variables. If the employee is determined to fully match a position then, at step 515 the employee is assigned to that position. In one embodiment, the 1^{st} line manager field of the row in the HR table would be updated to identify the 1^{st} line manager for the team.

If the employee doesn't fully match an open position, then at step 520 a determination is made as to whether the employee partially matches an open position. In certain embodiments, each matching variable is assigned a weight, typically a percentage from 1% to 100%, that defines its relative importance. In this step, a matching score is calculated between the employee and each open position on each team. For example, taking the above example of an open position defined as Location=Denver, Seniority=Senior, Skill=IT. Assuming weights are assigned as Location=75%, Seniority=50%, Skill=100%, then if the employee matches Location and Skill but not seniority then their matching score would be calculated as 0.75+1=1.75.

If an employee partially matches an open position on a team then at step 515 the employee is assigned to the team. In certain embodiments, an employee may be assigned to more than one position on a team. In other embodiments an employee is assigned only to one position, typically the position for which his/her matching score is highest. In certain embodiments an employee is determined to partially match a position if their matching score for the position is positive, i.e. at least one of their matching variables is a match for the position. In other embodiments, a threshold value for a matching score may be defined.

At step 525 a determination is made as to whether all non-managerial employees in the organization(s) being reorganized have been processed. If so then the method terminates, and processing resumes at step 430 of FIG. 4. If not, then processing flows back to step 505 and the next employee is processed.

FIG. 6 provides a visual illustration of the matching process described with reference to FIG. 5. In this example, an open position on a team is defined as Skill=IT, Seniority=Junior, and Location=Denver. Using HR Table 200, of FIG. 2, only one person, Benny Peabody, fully matches this position. Several other employees from HR Table 200 partially match the position and eight persons don't match any of the position requirements. A matching score can be computed for each individual based on the assigned weights (Skill=100%, Location=75%, Seniority=50%). Graphically, employees with higher matching scores will appear to the left of employees with lower matching scores.

FIG. 7 is a flowchart that illustrates one exemplary method 700 for balancing a group of teams relative to balancing criteria. Method 700 implements step 435 of method 400. At this step, a preliminary assignment of employees to teams in a new or modified organization has been made and method 700 will attempt to rebalance teams as necessary so as to comply with the established constraints.

Step 710 initiates a sub-method that is performed for each team. Similarly, step 715 initiates a sub-method that is performed for each balancing constraint or variable.

At step 720 the distribution of values for each balancing variable for each team is computed. For example, for the balancing variable “gender” the percentage of males and females is computed.

At step 725 a determination is made as to whether the team currently being processed is unbalanced relative to the balancing constraint being processed. For example, in the case of “gender”, if the constraint is that females should be 50% of the team and only 30% of the team are females, as computed at step 720 then the constraint is unbalanced relative to this constraint. If so, processing continues at step 730. If not, processing returns to step 715.

At step 730 a determination is made as to whether there is another team that has a complementary imbalance. A complementary imbalance refers to the case where the team being processed is low relative to the balancing constraint being processed and another team is high relative to the same constraint. For example, if the constraint on the balancing variable “seniority” is that at least 30% of the team members are junior level then a complementary imbalance is a case where one team has less than 30% junior staff while another team has over 30% and will remain at over 30% junior staff if one junior staff member is removed, i.e. swapped for a more senior staff member. If should be noted that matching variables for a position are taken into account at this step, thus, in the current example, any excess junior staff would have to at least partially match the criteria for the position(s) where there is an insufficient number of junior staff. At step 735 one or more staff are swapped to reduce the detected imbalance between the two teams.

At step 740 a determination is made as to whether all balancing variables have been processed. If not, then processing returns to step 715. If so then processing continues at step 745.

At step 745 a determination is made as to whether all teams have been processed. If not, then processing returns to step 710. If so, then the method terminates.

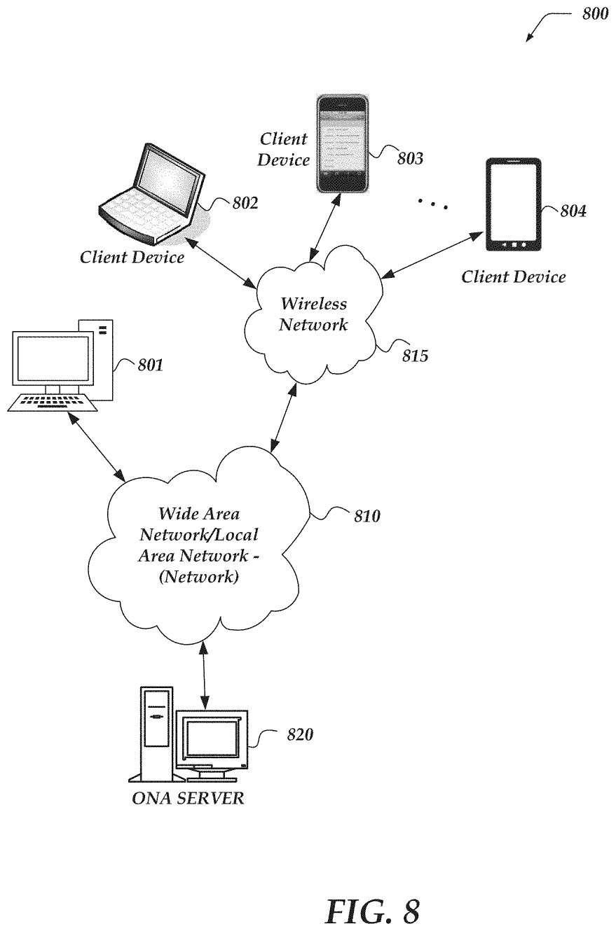

FIG. 8 is a system diagram that shows components of one exemplary operating environment in which the invention may be practiced. Not all of the components in exemplary operating environment 800 may be required to practice the invention, and variations in the arrangement and types of the components may be made without departing from the spirit or scope of the invention. System 800 includes a wide area network (“WAN”)/local area network (“LAN”)-(network) 810, a wireless network 815, client devices 801-804, and an ONA server 820.

Generally, client devices 801-804 include any computing devices that are capable of receiving and sending messages over a network, such as network 810 and/or wireless network 815, including personal computers, multiprocessor systems, microprocessor-based or programmable consumer electronics, network PCs, or the like. Client devices 801-804 also include mobile devices such as mobile telephones, smart phones, display pagers, radio frequency (RF) devices, infrared (IR) devices, personal digital assistants (PDAs), handheld computers, laptop computers, tablet computers, integrated devices combining one or more of the preceding devices, or the like.

Client devices 801-804 may include client application programs that send and receive content to/from other computing devices. Examples of application programs include calendars, browsers and email clients and so forth. A Web-enabled client device can communicate across the Web. It may include a browser application that is configured to receive and to send web pages, web-based messages, or the like. The browser application may receive and display graphics, text, multimedia, or the like, employing a web-based language, including a wireless application protocol messages (WAP), or the like.

Specifically, both user client computer 115 and webmaster client computer 155 are each embodiments of client devices 801-804. Network 160 is an embodiment of network 810 or wireless network 815 or a combination of both. Further, ONA server 130 is an embodiment of ONA server 820.

Network 810 is configured to couple ONA server 820, search engine 521, web server 522, and client device 801 with other computing devices, including through wireless network 815 to client devices 802-804. Network 810 can include the Internet in addition to local area networks (LANs), wide area networks (WANs), private networks, and the like.

Wireless network 815 is configured to couple client devices 802-804 with network 810. Wireless network 815 may include virtually any wireless communication mechanism by which information may travel from client devices 802-804 to another computing device or to another network.

ONA server 820 is a network computing device configured to receive messages from client devices 801-804 to respond to messages from client devices 801-804 and to perform a variety of functions on behalf of client devices 801-804. ONA server 820 typically uses standard Web and Web services protocols such as HTTP. ONA server 820 may be implemented, for example, as server computers, server computer farms, Web services, cloud services and the like.

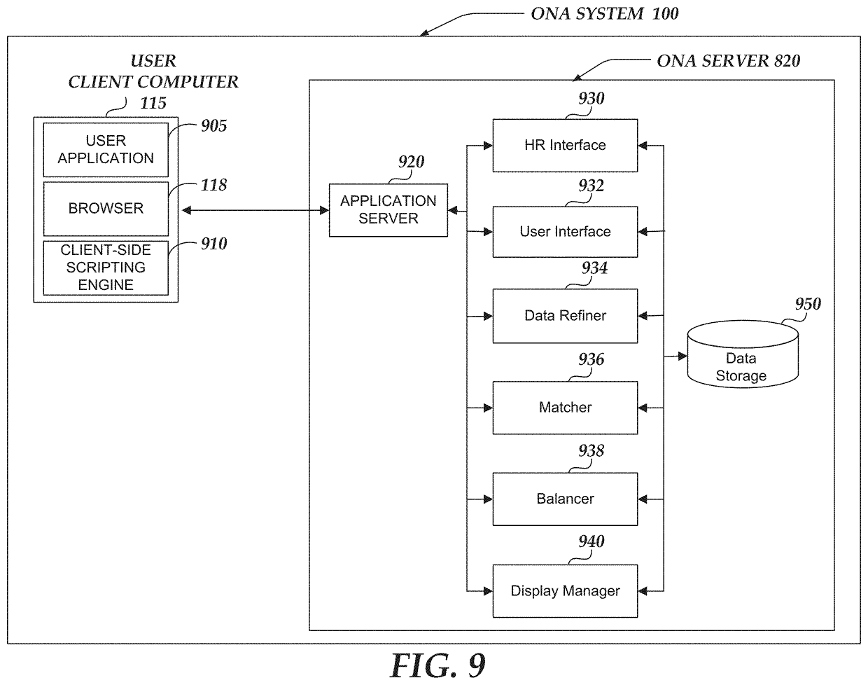

Network computing devices that may operate as ONA server 820 include but are not limited to personal computers, desktop computers, multiprocessor systems, microprocessor-based or programmable consumer electronics, network PCs, servers, network appliances, and the like. Further, a network computing device that may operate as ONA server 820 is not limited to a single network computing device; for example, a plurality of network devices may be configured to perform the functions of ONA server 820. One such configuration is a “server farm” that includes multiple server computers operating cooperatively, each performing some aspect of the processing associated with ONA server 820. One embodiment of the software modules that perform ONA server 820 functions is described with reference to FIG. 9 below.

ONA server 820 may also be implemented using a cloud service that provides computing services across the Internet. Examples include AMAZON AWS, and MICROSOFT AZURE, GOOGLE CLOUD, and IBM CLOUD.

ONA server 820 is capable of running application programs (“applications”). Applications that may be run by ONA server 820 include database programs, customizable user interface programs, security applications, encryption programs, VPN programs, web servers, applications servers, customer relationship management (CRM) systems, and so forth.

ONA server 820 typically provides web services which include any of a variety of network services that are configured to provide content, including messages, over a network to another computing device. Thus, web services include for example, an application server, a web server, a messaging server, a File Transfer Protocol (FTP) server, a database server, a content server, or the like. Web services may provide the content including messages over the network using any of a variety of formats, including, but not limited to WAP, HDML, WML, HTML, XML, JSON, SOAP or the like. Web services may also include server-side scripting languages such as PHP, Python, and Java servlets. Web services may also include the server side of the Ajax web development method that enables a server to asynchronously respond to Ajax requests.

ONA server 820 includes nonvolatile data storage for storing program code and data. Data storage may include virtually any mechanism usable for storing and managing data, including but not limited to a file, a folder, a document, a web page or an application, such as a database, digital media including digital images and digital video clips, and the like.

Data storage may further represent a plurality of different data stores. For example, data storage may represent a customer database, a web page database, a instruction database, and a keyword database such as those described below in conjunction with FIG. 9. Further, data storage may also include network storage or cloud storage in which the physical storage media is accessed across a network.

FIG. 9 is a block diagram that depicts the software modules of organizational network analysis (ONA) server 820.

In a preferred embodiment, user 110 interacts with ONA server 820 using a user application 905 that is downloaded to web browser 118 from an application server 920 that runs in ONA server 820. In a preferred embodiment, user application 905 is a Web application, that is written using standard Web programming languages such as HTML, JAVASCRIPT, and JAVA, and is executed by browser 118 running in user client computer 115.

Browser 118 is typically a standard, commercially available, browser such as MOZILLA FIREFOX or MICROSOFT INTERNET EXPLORER. Alternatively, it may also be a client application configured to receive and display graphics, text, multimedia, and the like, across a network.

In one embodiment, browser 118 interacts with a client-side scripting engine 910 that executes client-side scripting instructions written in a client-side scripting or programming language such as JAVASCRIPT® from ORACLE CORPORATION of Redwood Shores, Calif., the Java open source programming language, ACTIVEX® from the MICROSOFT CORPORATION of Redmond, Wash., and the like. In one embodiment, browser 118 is configured to use the Ajax (asynchronous JavaScript and XML or JSON) web development techniques that enable Web browsers to asynchronously request incremental pieces of information from the server instead of whole pages.

In one embodiment, when user 110 accesses ONA server 820 using user application 905, ONA server 820 downloads web pages in HTML format to browser 118 for viewing and interactive use. To perform some of the advanced client-side interactive functions the web pages may include client-side scripting instructions. Typically, such client-side scripting instructions are embedded in HTML web pages and are interpreted or executed by client-side scripting engine 910 to perform functions not available through HTML commands such as advanced graphics, database access, and computations.

In one embodiment, JavaScript is used as a client-side scripting language. JavaScript is standardized by the European Computer Manufacturers Association (ECMA) and is supported by most commercial browsers including MOZILLA FIREFOX, MICROSOFT INTERNET EXPLORER AND APPLE SAFARI.

User application 905 issues HTTP requests to and receives HTTP responses from application server 920 via browser 118. Application server 920 receives the HTTP requests and invokes the appropriate ONA server 820 software module to process the request. Application server 920 may be a commercially available application server that includes a web server that accepts and processes HTTP requests transmits HTTP responses back along with optional data contents, which may be web pages such as HTML documents and linked objects (images, or the like). In addition, browser 118 may use Ajax to issue requests for XML or JSON-coded information that is delivered asynchronously by application server 920. Henceforth, the term request message refers to a message sent by browser 118 using HTTP, Ajax or other client-server communications method to ONA server 820. And a response message refers to a message sent in response, typically using the same communications method, by application server 920 running in ONA server 820.

Application server 920 establishes and manages user 110 sessions. Typically, application server 920 assigns each session a unique session id. A session lasts from the time user 110 logs in, or accesses ONA server 820, until the time user 110 logs out or stops interacting with ONA server 820 for a specified period of time. In addition, application server 820 manages server applications and provides database connectivity.

Upon request by browser 118, application server 920 provides the HTML, JavaScript and other browser-executable code that make up user application 905.

ONA server 820 includes a HR interface 930, a user interface 932, a data refiner 934, a matcher 936, a balancer 938 and a display manager 940. ONA server 820 further includes a data storage 950.

HR interface 930 interacts with HR 120 to receive HR tables as well as constraint information. In certain embodiments, it stores this information in data storage 950.

User interface 932 interacts with user 110 by providing user interfaces and receiving information entered by user 110 into user application 905.

Data refiner 934 performs aspects of the processing associated with method 400 including step 415, refining data.

Matcher 936 performs the processing to match employees with teams, described with reference to FIGS. 4-6.

Balancer 938 performs the processing to balance teams relative to constraints, described with reference to FIGS. 4 and 7.

Display manager 950 prepares organizational information for display. It performs the processing associated with steps 440 and 445 of method 400.

Data storage 950 may be implemented using a commercial database management system (DBMS). In certain embodiments, the DBMS is a relational DBMS (RDBMS) such as ORACLE® from the Oracle Corporation, SQL Server from the Microsoft Corporation, or the like. However, other database managers may also be used. In one embodiment, data storage 950 is implemented as one or more relational databases and is accessed using the structured query language (SQL). Further, data storage 950 may be implemented as one or more computer files spread across one or more physical storage mechanisms.

Data storage 950 stores HR tables received from HR 120. It also stores new tables, results data, and display data.

The above specification, examples, and data provide a complete description of the manufacture and use of the composition of the invention. Since many embodiments of the invention can be made without departing from the spirit and scope of the invention, the invention resides in the claims hereinafter appended.

What is claimed is:

1. A server-implemented method for performing a simulation of a new organization, comprising:
receiving (1) information about teams in a new organization, (2) information about open positions on the teams, (3) at least one employee table that provides records for a plurality of employees, wherein at least one of the employees is to be assigned to a position on a team in the new organization; (3) matching constraints that are used to match employees with positions, and (4) balancing constraints that are used to balance teams;
creating a target table that includes a row for each employee to be assigned to a team in the new organization;
for at least one employee to be assigned to a team, determining that the employee matches an open position on a team based on the matching constraints; and
assigning the employee to the open position on the team; and
for at least one team, reassigning an employee to a different team based on the balancing constraints.

2. The method of claim 1 wherein the at least one employee table comprises (1) a table of non-managerial employees from an acquired organization, and (2) a table of non-managerial employees from an acquiring organization, and wherein a table of non-managerial employees for an organization includes a row for each non-managerial employee in the organization wherein a row for a non-managerial employee includes a column that specifies a first line manager, and wherein creating a target table comprises (1) creating a new table that includes each of the rows of the table from the acquired organization and each of the rows of the table from the acquiring organization, and (2) removing information about the first line manager from each row in the target table that corresponds to an employee in the acquired organization.

3. The method of claim 1 wherein the at least one employee table comprises (1) a table of non-managerial employees from a first organization to be merged, and (2) a table of non-managerial employees from a second organization to be merged, and wherein a table of non-managerial employees for an organization includes a row for each non-managerial employee in the organization wherein a row for a non-managerial employee includes a column that specifies a first line manager, and wherein creating a target table comprises (1) creating a new table that includes each of the rows of the table from the first organization and each of the rows of the table from the second organization, and (2) removing information about the first line manager from each row in the target table.

4. The method of claim 1 wherein the at least one employee table comprises a table of non-managerial employees from an organization being reorganized, and wherein creating a target table comprises (1) creating a new table that includes each of the rows of the table from the organization being reorganized, and (2) removing information about the first line manager from each row in the target table.

5. The method of claim 1 wherein determining that the employee matches an open position on a team comprises:
determining that employee fully matches the criteria for at least one open position associated with the one team.

6. The method of claim 1 wherein determining that the employee matches an open position on a team comprises:
determining that employee does not fully match the criteria for any open position on the team; and
determining that employee partially matches the criteria for at least one position on the team.

7. The method of claim 1 wherein reassigning an employee to a different team based on the balancing constraints comprises:
determining that the team the employee is assigned to has an imbalance with respect to a balancing constraint;
determining that a different team has a complementary imbalance with respect to the balancing constraint; and
swapping the employee with an employee on the different team.

8. The method of claim 1 further comprising:
creating a table for employees that could not be matched; and and
for each employee that did not match a team, assigning the employee to the table for employees that could not be matched.

9. The method of claim 1 wherein at least one matching constraint is selected from the group consisting of location, skill, seniority, and education.

10. The method of claim 1 wherein at least one balancing constraint is selected from the group consisting of age group, gender, race, team size, seniority, education, and engagement.

11. A server computer, comprising:
a processor;
a communication interface in communication with the processor;
a data storage for storing results;
a nontransitory memory in communication with the processor for storing instructions, which when executed by the processor, cause the server:
to receive (1) information about teams in a new organization (2) information about open positions on the teams, (3) at least one employee table that provides records for a plurality of employees, wherein at least one of the employees is to be assigned to a position on a team in the new organization; (3) matching constraints that are used to match employees with positions, and (4) balancing constraints that are used to balance teams;
to create a target table that includes a row for each employee to be assigned to a team in the new organization;
for at least one employee to be assigned to a team, to determine that the employee matches an open position on a team based on the matching constraints; and
to assign the employee to the open position on the team; and
for at least one team, to reassign an employee to a different team based on the balancing constraints.

12. The device of claim 11 wherein the at least one employee table comprises (1) a table of non-managerial employees from an acquired organization, and (2) a table of non-managerial employees from an acquiring organization, and wherein a table of non-managerial employees for an organization includes a row for each non-managerial employee in the organization wherein a row for a non-managerial employee includes a column that specifies a first line manager, and wherein creating a target table comprises (1) creating a new table that includes each of the rows of the table from the acquired organization and each of the rows of the table from the acquiring organization, and (2) removing information about the first line manager from each row in the target table that corresponds to an employee in the acquired organization.

13. The device of claim 11 wherein the at least one employee table comprises (1) a table of non-managerial employees from a first organization to be merged, and (2) a table of non-managerial employees from a second organization to be merged, and wherein a table of non-managerial employees for an organization includes a row for each non-managerial employee in the organization wherein a row for a non-managerial employee includes a column that specifies a first line manager, and wherein creating a target table comprises (1) creating a new table that includes each of the rows of the table from the first organization and each of the rows of the table from the second organization, and (2) removing information about the first line manager from each row in the target table.

14. The device of claim 11 wherein the at least one employee table comprises a table of non-managerial employees from an organization being reorganized, and wherein creating a target table comprises (1) creating a new table that includes each of the rows of the table from the organization being reorganized, and (2) removing information about the first line manager from each row in the target table.

15. The device of claim 11 wherein determining that the employee matches an open position on a team comprises:
determining that employee fully matches the criteria for at least one open position associated with the one team.

16. The device of claim 11 wherein determining that the employee matches an open position on a team comprises:
determining that employee does not fully match the criteria for any open position on the team; and
determining that employee partially matches the criteria for at least one position on the team.

17. The device of claim 11 wherein reassigning an employee to a different team based on the balancing constraints comprises:
determining that the team the employee is assigned to has an imbalance with respect to a balancing constraint;
determining that a different team has a complementary imbalance with respect to the balancing constraint; and
swapping the employee with an employee on the different team.

18. The device of claim 1 wherein the instructions, when executed by the processor, further cause the server:
to create a table for employees that could not be matched; and and
for each employee that did not match a team, assigning the employee to the table for employees that could not be matched.

19. The device of claim 11 wherein at least one matching constraint is selected from the group consisting of location, skill, seniority, and education.

20. The device of claim 11 wherein at least one balancing constraint is selected from the group consisting of age group, gender, race, team size, seniority, education, and engagement.
